(19) United States
(12) Patent Application Publication
(10) Pub. No.: US 2007/0146061 A1
(43) Pub. Date: Jun. 28, 2007

(54) CMOS REFERENCE VOLTAGE SOURCE

(75) Inventor: Santiago Iriarte, Munich (DE)

Correspondence Address: TEXAS INSTRUMENTS INCORPORATED, P O BOX 655474, M/S 3999, DALLAS, TX, 75265, US

(73) Assignee: TEXAS INSTRUMENTS DEUTSCHLAND GMBH, Freising (DE)

(21) Appl. No.: 11/536,809

(22) Filed: Sep. 29, 2006

(30) Foreign Application Priority Data
Sep. 30, 2005 (DE) 10 2005 047033.5
Sep. 15, 2006 (DE) 10 2006 043453.6

(51) Int. Cl. G05F 1/10

(52) U.S. Cl. 327/543; 327/539

(57) ABSTRACT

A CMOS reference voltage source comprises first and second circuit branches connected in parallel between supply terminals, so that the current in one branch is mirrored in the other, and vice versa. The first circuit branch includes a series connection of a first transistor (MP1) of a first conductivity type, a first transistor (MN1) of a second conductivity type and a second transistor (MN2) of the second conductivity type. The second circuit branch includes a series connection of a second transistor (MP2) of the first conductivity type, a third transistor (MN3) of the second conductivity type and a fourth transistor (MN4) of the second conductivity type. The reference voltage is provided at an interconnection node between the third and fourth transistors (MN3, MN4) of the second conductivity type. No resistors or bipolar devices are needed so that a standard CMOS process can be used.

### BACKGROUND

Conventional reference voltage sources for a relatively low voltage are bandgap references. At very low currents these need resistors of a very high value. Resistors of a high value need a large chip area. Bipolar devices are also needed for a bandgap reference. Accordingly, a standard CMOS process cannot be used. A bandgap reference is, however, typically of a greater accuracy than needed for some very low power applications. For some very low power applications (e.g., less than 100 nA), a reference voltage source does not have to be very accurate. An accuracy of 10% over process may be acceptable.

### SUMMARY

In one embodiment, the invention provides a CMOS reference voltage source with two circuit branches connected in parallel between supply terminals. Each circuit branch includes a series connection of a first transistor of a first conductivity type and two transistors of the opposite conductivity type. The transistors are connected so that each circuit branch mirrors the current flowing in the other circuit branch. One of the two circuit branches provides a reference current. The reference current that flows through a diode-connected transistor of that circuit branch causes a substantially constant voltage drop across the diode-connected transistor which can be used as a reference voltage.

The inventive CMOS reference voltage source uses only MOS transistors and can be implemented in a standard CMOS process. It has a very small power consumption and requires only a small chip area. No resistors and bipolar devices are needed.

In a further embodiment, the circuit branch that provides the reference current includes two or more similar diode-connected transistors in series. In this case, the reference voltage at the output is a multiple of the transistor threshold voltage; whereas in a conventional bandgap reference the output level is fixed.

### BRIEF DESCRIPTION OF THE DRAWINGS

Further advantages and features of the invention will appear from the following detailed description with reference to the appending drawings, wherein:

FIG. 1 (Prior Art) is a schematic circuit diagram of a conventional reference voltage source;

FIG. 2 is a schematic circuit diagram of a basic form of a reference voltage source in accordance with the principles of the invention;

FIG. 3 is a schematic circuit diagram of an example embodiment of the reference voltage source according to the invention; and

FIG. 4 is a schematic circuit diagram of a further embodiment of the reference voltage source according to the invention.

### DETAILED DESCRIPTION OF THE DRAWINGS

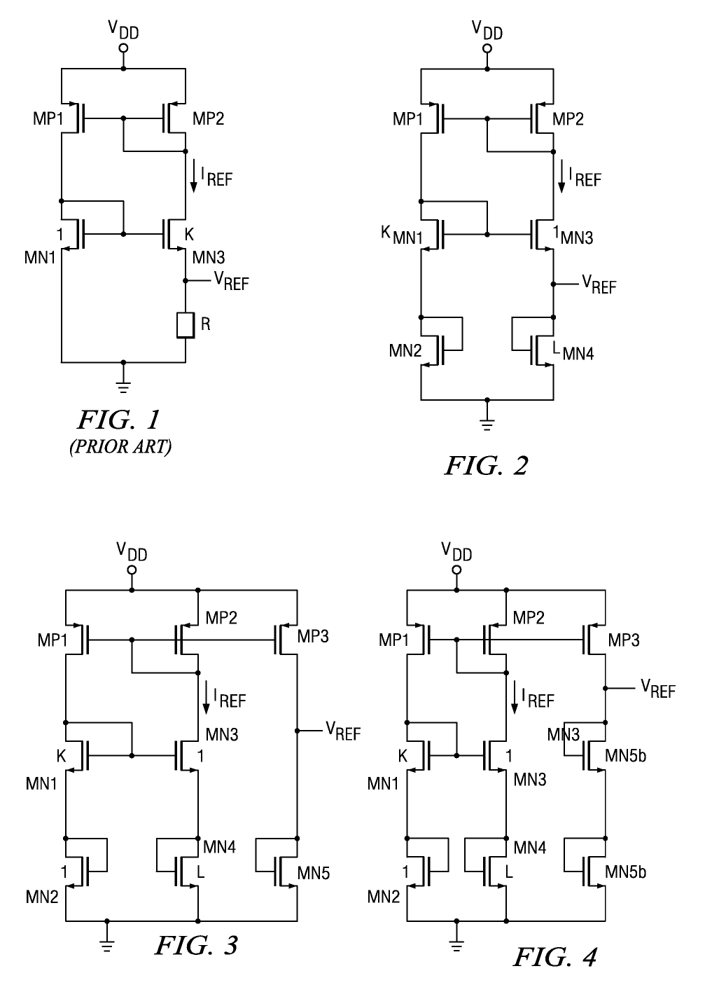

FIG. 1 shows a conventional voltage reference generator which requires a resistor R of very high value for a very low power application. Specifically, the circuit in FIG. 1 has two circuit branches connected in parallel between supply terminal V_{DD} and ground. The first branch is a series connection of a p-channel MOS transistor MP1 and a diode-connected n-channel MOS transistor MN1. The second branch is a series connection of a diode-connected p-channel transistor MP2, an n-channel MOS transistor MN3 and a resistor R. Transistors MP1 and MP2 have their gates interconnected, as do the transistors MN1 and MN3. As a result, the current in each one of the two circuit branches is mirrored in the respective other circuit branch. Transistors MN1 and MN3 are sized in a ratio of 1:K. This determines the current in the second circuit branch, which is assumed to be a reference current I_{REF}. The reference current I_{REF} develops a reference voltage V_{REF} across resistor R, which is the output of the reference voltage source. The requirement for a high resistance value resistor in the circuit of FIG. 1 is problematic in a low-power application because high resistance values require a large die area for fabrication.

FIG. 2 shows a basic implementation of the reference voltage source according to the principles of the invention. It has only six transistors and no resistor (the start-up circuit portion not being shown).

Specifically, the inventive circuit of FIG. 2 has the same basic structure as the circuit in FIG. 1, but the first circuit branch includes a diode-connected n-channel tail transistor MN2, and the second circuit branch has a diode-connected n-channel-transistor MN4 in the place of the resistor R in FIG. 1. In the FIG. 2 embodiment, the generated current is approximately proportional to the square root of temperature. The output voltage V_{REF} is approximately equal to (i.e., some 100 mV higher than) the threshold voltage (V_{TH}) of an NMOS transistor (PMOS can also be used) and is very stable over temperature (60 ppm simulated). The output voltage varies over process with the transistor threshold voltage, but such variations remain within an acceptable 10% for the very low power applications of interest here.

FIGS. 3 and 4 show further embodiments of the inventive CMOS reference voltage source. They all include a basic configuration as shown in FIG. 2.

In the embodiment of FIG. 3, a third circuit branch comprising a p-channel MOS transistor MP3 connected in series with a diode-connected n-channel MOS transistor MN5 is connected between supply terminal V_{DD} and ground. Transistor MP3 has its gate connected with the gates of transistors MP1 and MP2, and so the third circuit branch mirrors the reference current I_{REF}, and the gate-source voltage V_{GS} developed across transistor MN5 provides the desired reference voltage V_{REF}.

In the embodiment of FIG. 4, the only change over FIG. 3 is that the transistor MN5 is replaced by a series connection of two similar diode-connected n-channel MOS transistors MN5a and MN5b, thereby multiplying the output voltage V_{REF} by a factor of two. It should be understood that more than two such transistors could be used in replacement of the single transistor MN5 in FIG. 3, to increase the output voltage correspondingly. In a similar manner, the diode-connected transistor MN4 in the basic embodiment of FIG. 2 can be replaced by a series connection of multiple similar transistors to increase the level of the output reference voltage.

It should be understood that in the embodiments disclosed, the conductivity type of MOS transistors could be inverted. Also, it should be clear that the circuit disclosed herein can also be used as a current generator since a reference current is generated that just needs to be mirrored out of the circuit.

Those skilled in the art to which the invention relates will appreciate that various additions, deletions, substitutions and other modifications may be made to the foregoing described example embodiments, and that other embodiments may be developed, all within the scope of the claimed invention.

What is claimed is:

1. A reference voltage source comprising:
first and second circuit branches connected in parallel between supply terminals, so that the current in one branch is mirrored in the other, and vice versa;
the first circuit branch including a series connection of a first MOS transistor of a first conductivity type, a first MOS transistor of a second conductivity type, and a second MOS transistor of the second conductivity type; and
the second circuit branch including a series connection of a second MOS transistor of the first conductivity type, a third MOS transistor of the second conductivity type, and a fourth MOS transistor of the second conductivity type.

2. The reference voltage source of claim 1, wherein:
the gates of the first and second MOS transistors of the first conductivity type are connected, and one of the first and second MOS transistors of the first conductivity type has its gate connected to its drain;
the gates of the first and third MOS transistors of the second conductivity type are connected, and one of the first and third MOS transistors of the second conductivity type has its gate connected to its drain; and
the second and fourth MOS transistors of the second conductivity type each have their gates connected to their drains.

3. The reference voltage source of claim 2, wherein an output reference voltage is provided across the fourth MOS transistor of the second conductivity type.

4. The reference voltage source of claim 1, including a third circuit branch connected in parallel with the first and second circuit branches; the third circuit branch including a third MOS transistor of the first conductivity type connected in series with at least one diode-connected fifth MOS transistor of the second conductivity type.

5. The reference voltage source of claim 4, wherein:
the gates of the first, second and third MOS transistors of the first conductivity type are connected, and one of the first and second MOS transistors of the first conductivity type has its gate connected to its drain;
the gates of the first and third MOS transistors of the second conductivity type are connected, and one of the first and third MOS transistors of the second conductivity type has its gate connected to its drain; and
the second and fourth MOS transistors of the second conductivity type each have their gates connected to their drains.

6. The reference voltage source of claim 5, wherein an output reference voltage is provided across the at least one fifth MOS transistor of the second conductivity type.

7. The reference voltage source of claim 6, wherein the at least one fifth MOS transistor of the second conductivity type comprises a series connection of two diode-connected transistors of the second conductivity type, and the output reference voltage is provided across said series connection of said two transistors.

8. A reference voltage source comprising:
first and second circuit branches connected in parallel between supply terminals;
the first circuit branch including a series connection of a first PMOS transistor, a first NMOS, and a second NMOS transistor; and
the second circuit branch including a series connection of a second PMOS transistor, a third NMOS transistor, and a fourth NMOS transistor:
wherein the gates of the first and second PMOS transistors are connected, and the second PMOS transistor has its gate connected to its drain; the gates of the first and third NMOS transistors are connected, and the first NMOS transistor has its gate connected to its drain; and the second and fourth NMOS transistors each have their gates connected to their drains.

9. The reference voltage source of claim 8, wherein an output reference voltage is provided across the fourth NMOS transistor.

10. The reference voltage source of claim 7, further including a third circuit branch connected in parallel with the first and second circuit branches, the third circuit branch including a third PMOS transistor connected in series with at least one diode-connected fifth NMOS transistor; and wherein the gate of the third PMOS transistor is connected with the gates of the first and second PMOS transistors, and an output reference voltage is provided across the at least one diode-connected fifth NMOS transistor.

11. The reference voltage source of claim 10, wherein the at least one fifth MOS transistor of the second conductivity type comprises a series connection of two diode-connected NMOS transistors, and the output reference voltage is provided across said series connection of said two diode-connected NMOS transistors.
